(19) United States
(12) Patent Application Publication
(10) Pub. No.: US 2003/0221914 A1
(43) Pub. Date: Dec. 4, 2003

(54) Portable lift for rack mounting equipment

(76) Inventors: Paul L. Smith, Drexel Hill, PA (US); Michael P. Smith, Ridley Park, PA (US)

Correspondence Address: Richard C. Litman, LITMAN LAW OFFICES, LTD., P. O. Box 15035, Arlington, VA, 22215, US

(21) Appl. No.: 10/445,884

(22) Filed: May 28, 2003

Related U.S. Application Data
(60) Provisional application No. 60/383,125, filed on May 28, 2002.

(51) Int. Cl. B66F 9/06; B66F 9/20

(52) U.S. Cl. 187/244; 187/243; 187/231; 187/232; 187/235

(57) ABSTRACT

A portable lift system for transporting and installing electronic systems within a rack system having a lockable rolling support structure including an upright mast, a base and a telescoping support carriage or shelf. The base has first and second telescoping support members which are integrally formed with lockable wheel castors for multi-directional rolling contact with a variety of rolling contact surfaces. The telescopic support members are stabilized by an integrally attached coupler for enabling simultaneous rolling and telescopic motion of the base in a direction perpendicular with respect to a base portion of the mast. The base also includes a lifting assembly which has a carriage connector, at least one motor, a motor support member and a line dispenser.

### CROSS-REFERENCE TO RELATED APPLICATION

This application claims the benefit of U.S. Provisional Patent Application Serial No. 60/383,125, filed May 28, 2002.

### BACKGROUND OF THE INVENTION

1. Field of the Invention

The present invention relates generally to lifting devices. More specifically, the invention is a portable lift system for transporting and inserting electronic equipment in narrow spaces, such as server cabinet or rack systems.

2. Description of Related Art

Numerous lift systems have been devised to selectively elevate users for construction or other manual driven occupations. Most conventional lift systems are notably used in the painting industry and/or in the power supply industry in which the repairing of power lines and the need for changing and/or repairing lights are required along streets, highways or busy intersections. The primary advantage of conventional lift systems rests in the elevating feature, special supports, and operative features which serve to facilitate the reaching of objects, mechanisms or areas in high places. A set back, however, is seen in the enormous power requirements, the complexity of the lifting system, and potential health risks which often translate into increased costs for maintenance and/or repairs and ultimately the cost of a human life from operator related malfunctions. The portable lift system as herein described has the primary advantage of delivering heavy computer equipment or the like while in transport to narrow storage or rack areas thereby minimizing the aforementioned problems related to conventional lift systems.

The first class of lifting systems are noted for use with trucks or elevator lifts required for painting and the like. U.S. patents issued to Winkelblech (U.S. Pat. Nos. 4,324,317 and 4,427,094), Wilke et al. (U.S. Pat. No. 5,368,130), Niebuhr et al. (U.S. Pat. No. 6,125,971) and Namba et al. disclose truck and elevator related lift systems, respectively.

U.S. Pat. No. 4,619,439, issued to Riedl et al., discloses a lifting and depositing device for portable containers, compartments and container shelters which require the attachment of rack and pinion jacks. A similar lift system which utilizes an adjustable chassis is described in the U.S. patent issued to Hanthorn (U.S. Pat. No. 4,793,437). This lift system requires the use of platform level adjusters for leveling the lift, particularly when disposed at an incline.

U.S. Pat. No. 5,848,668, issued to Kafrissen et al., discloses a miniature lifting device which is used to transport equipment with nominal elevating or height requirements. U.S. patents issued to Berends et al. (U.S. Pat. No. 5,911,408) and Beattie (U.S. Pat. No. 6,035,972) describe heavy-duty transportable lifts which are arranged opposite in principle compared to the patent issued to Kafrissen such that the bases of the respective lifting supports are arranged to support and vertically lift a load relative to the base. A control unit is used to selectively disable wheels, elevating means, or the like.

Patents respectively issued and granted to Mishler (Des. 365,907), Bushnell (GB 1 456 911), Hans (DE 3536492) and Huntley (EP 0 555 025 A1) disclose lift related systems which are considered to be of general relevance to the portable lift system as herein described.

None of the above inventions and patents, taken either singly or in combination, is seen to describe the instant invention as claimed.

### SUMMARY OF THE INVENTION

The portable lift system for transporting and installing electronic systems according to the invention includes a rolling support structure with lockable wheels having an upright mast, a base and a telescoping support carriage or shelf. The base has first and second telescopic support members which are integrally formed with lockable wheel castors for multi-directional rolling contact with a variety of rolling contact surfaces. The telescopic support members are stabilized by an integrally attached coupler for enabling simultaneous rolling and telescopic motion of the base in a direction normal to a base portion of the mast. The base also includes a lifting assembly which has a carriage connector or shelf, at least one motor, a motor support member and a line dispenser. The line or cable dispenser is rotatably connected to a shaft of the motor for selectively lifting and lowering various electrical components.

A pulley and pulley support structure is mounted to a top portion of the mast opposite the base for dynamically interconnecting the carriage support with the carriage connector via a take-up knob assembly to at least one slidable carriage support bar with roller bearings, the carriage assembly being constrained to move within a first and second beam portion of the mast, along its length. The take-up knob assembly allows a user to make fine adjustments in the carriage or shelf for lining up screw holes and/or equipment disposed within a server storage network or similar structure. Gripping supports are provided on the rear and parallel with the shelf for manual manipulation of the lift during rolling or other transport.

A U-shaped gripping bar is rotatably lowered from a vertical position to a substantially 90 degree angle in front of the lift to allow for pulling transport of equipment from the front. The U-shaped front gripping bar rests on a first and second support plate, respectively. Adjacent to a rear gripping support is disposed a conveniently located control module for operatively controlling the on/off lifting features of the lift system. An auxiliary locking mechanism is mounted to the lift to provide a releasable link to secure the telescoping base in a locked position at each respective end of the telescoping base.

Accordingly, it is a principal object of the invention to provide a portable lift system for rack mounting equipment.

It is another object of the invention to provide a portable lift system which operates to insert heavy equipment within narrow passages at user selectable heights.

It is a further object of the invention to provide a lifting system which minimizes the requirement for physical prowess to lift and install servers or similar systems within narrow spaces.

It is an object of the invention to provide improved elements and arrangements thereof in an apparatus for the purposes described which is inexpensive, dependable and fully effective in accomplishing its intended purposes.

These and other objects of the present invention will become readily apparent upon further review of the following specification and drawings.

### BRIEF DESCRIPTION OF THE DRAWINGS

FIG. 1A is an environmental, perspective view of a portable lift system for rack mounting equipment according to the present invention.

FIG. 1B is a partial, perspective view of a portable lift system according to the present invention, illustrating a bottom telescoping wheel locking feature.

FIG. 2 is a perspective view of the portable lift system, illustrating telescoping and directional lift features of the invention.

FIG. 3 is a perspective view of the portable lift system used in combination with a rack system for servers.

Similar reference characters denote corresponding features consistently throughout the attached drawings.

### DETAILED DESCRIPTION OF THE PREFERRED EMBODIMENTS

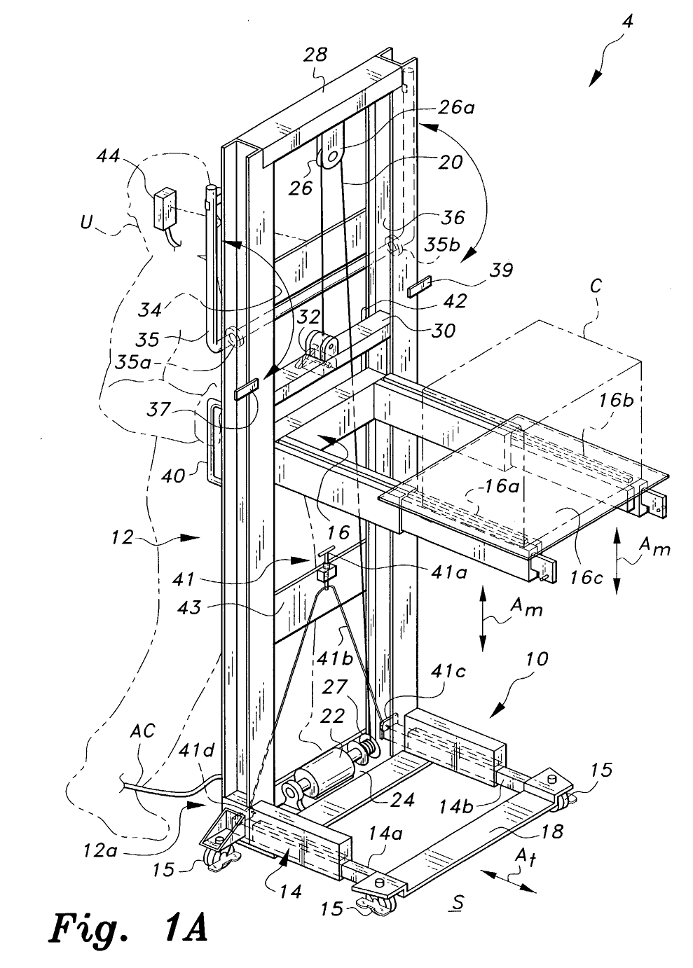

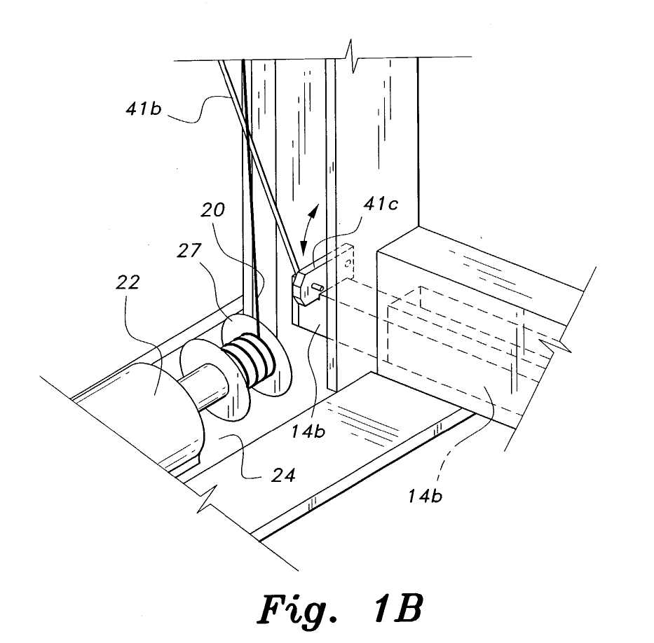

The present invention is directed to a portable lift system for transporting and installing electronic equipment within rack systems. The preferred embodiments of the invention are depicted in FIGS. 1A-3, and are generally referenced as numerals 4 and 5, respectively.

As best seen in FIGS. 1A and 1B, the lift system 4 is shown comprising a rolling support structure 10 having an upright mast 12, a base 14 and a support carriage 16 having a telescoping shelf 16c. The base 14 is constructed to include first and second telescopic support members 14a and 14b, respectively. As shown therein, the telescopic support members 14a,14b include integrally formed first and second lockable wheel castors 15 for multi-directional rolling contact with a rolling contact surface S. The telescopic support members 14a,14b are integrally formed as a single unit via a coupling structural support 18 which enables simultaneous rolling and telescopic motion as indicated by the respective direction arrows Aₜ and Aₘ. The telescopic motion of the support members 14a,14b is made in a direction perpendicular with respect to a base portion 12a of the mast 12, and include a lock mechanism 41 having a spring-loaded activation knob 41a, a V-shaped link attachment 41b with first and second free ends for pivotal attachment to respective first and second pivoting lock plates 41c and 41d. The dynamic locking feature of the mechanism 41 is more clearly shown in FIG. 1B, illustrating lockable attachment to support member 14b.

The base 14 further illustrates a lifting assembly 25 comprising a carriage connector cable 20 of predetermined gauge and length, at least one motor 22, a corresponding motor support member 24 for securely mounting each motor thereto and at least one line dispenser 27 which is rotatably and fixedly connected to the motor 22 for selectively lifting and lowering transported components C via the carriage support 16. Motor support member is fixed to mast 12.

At least one pulley 26 and pivot support 26a is rigidly secured to a pulley support bar 28 fixed to the mast 12 via conventional methods for dynamically interconnecting the carriage support 16 with the carriage connector cable 20 to at least one slidable carriage support bar 30 via a single ring or loop support 32 fixedly attached thereto. The slidable support bar 30 further comprises at least one roller bearing support 33 disposed on first and second ends 30a and 30b of the slidable support bar 30, respectively. The support bar 30 is constrained to move within a first and second beam portions 34,36 of the mast 12 along its entire length powered by the at least one motor 22.

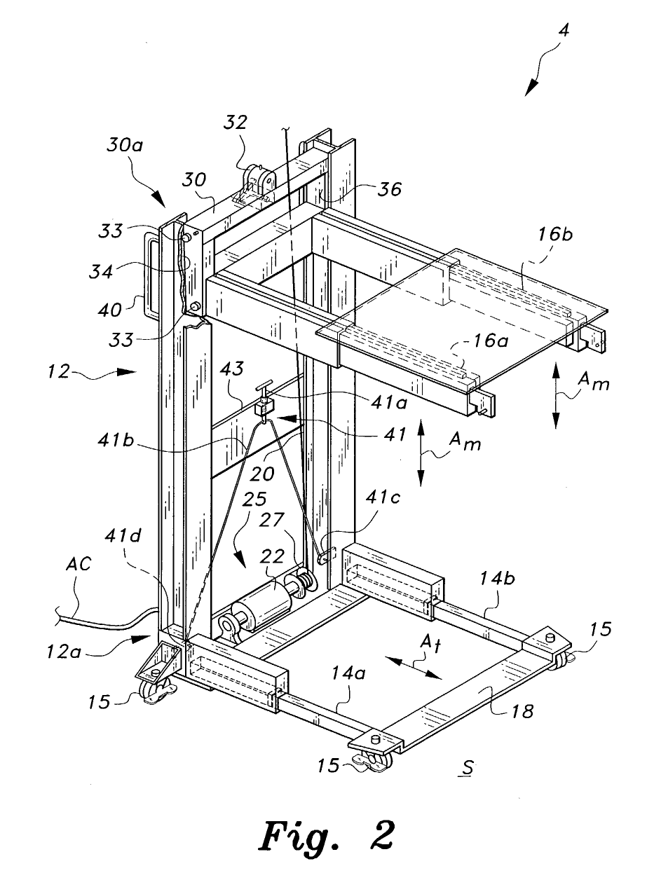

As diagrammatically illustrated in FIG. 2, the lift system 4 is shown to illustrate lifting and telescoping features of the carriage support 16 and base 14, respectively. The carriage support 16 is preferably U-shaped having first and second telescoping support arms 16a and 16b. Each support arm 16a,16b fixedly supports a shelf 16c on an end of each respective support arm 16a,16b such that each respective end slidably recesses within the carriage support 16 as a telescoping shelf, respectively. Also shown in FIG. 2, are the inclusive use of first and second gripping supports 40 and 42 fixedly mounted to first and second portions of the mast 12 for manual manipulation by a user U during rolling or other transport. The lift system 4 further includes an electronic control module 44 for conveniently and electronically controlling the lifting assembly. The control module 44 includes at least one operative switch for turning on and off the motor 22.

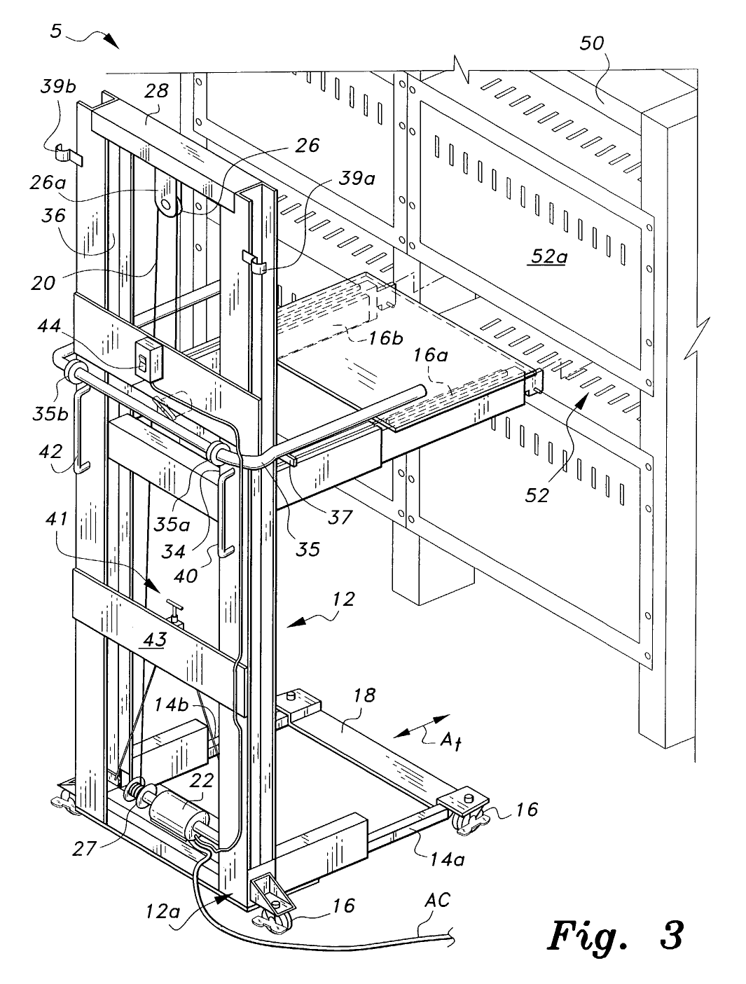

An auxiliary gripping support 35 is also shown as a substantially U-shaped member 35 which is rotatably fixed to the upright mast 12 via first and second supports 35a and 35b, respectively. In a downward position, the U-shaped gripping support 35 rests on respective first and second restraints 37 and 39. In an upright position, the U-shaped gripping support 35 is clamped by respective first and second restraints 39a and 39b, as diagrammatically illustrated in FIG. 3. Further illustrated in FIG. 3, is system 5 comprising the lift system 4 in combination with a rack server system 50. As shown therein, the support carriage 16 is made to fit between narrow clearances 52 for inserting and installing a server or other electronic devices within the rack system 50 at selective heights and subsequently secured therein via a single server panel 52a. With respect to power requirements, the lift systems 4,5 operate with either alternating current (AC) from a local wall outlet or via direct current (DC) or an on-board battery source.

It is to be understood that the present invention is not limited to the sole embodiments described above, but encompasses any and all embodiments within the scope of the following claims.

I claim:

1. A portable lift system for transporting and installing electronic systems, comprising:
a rolling support structure having an upright mast, a base, and a support carriage having a carriage support;
said base having first and second telescopic support members, said telescopic support members having internally formed therewith first and second lockable wheels for rolling contact with a rolling contact surface;
said mast having an upper portion and a lower portion and having first and second upright beam portions;
said first and second telescopic support members being integrally formed with a coupling support therebetween for enabling simultaneous rolling and telescopic motion in a direction perpendicular with respect to a base portion of said mast;
a lifting assembly comprising a carriage connector cable, at least one motor, at least one motor support member, and at least one line dispenser driven by said motor for selectively lifting and lowering the system via said carriage support;
said lifting assembly further comprising a pulley and a support at said upper portion of said mast dynamically interconnecting said carriage support with said said carriage connector cable to a slideable support bar via a single loop support, said slideable support bar being constrained to move within said first and said second mast beam portion along the length of the mast and with respect to said motor support member.

2. The lift system according to claim 1, further comprising a carriage shelf wherein said carriage support comprises first and second support arms having forward ends and said carriage shelf is attached to said first and second support arms at their respective forward ends.

3. The lift system according to claim 1, wherein said mast further comprises a first gripping support mounted on said first mast beam and second gripping support mounted on said second mast beam for manual rolling transport of the system.

4. The lift system according to claim 3, further comprising a motor control module mounted on said mast for controlling lifting power features of said lifting assembly, said control module including at least one operative switch for controlling direction and turning on and off said motor.

5. The lift system according to claim 3, further comprising a lock mechanism for locking said telescopic base support members comprising:
a lock mechanism having a spring-loaded activation knob and a knob support attached between said first and second upright beam portions, said knob being centrally mounted on said knob support;
first and second pivoting lock plates pivotally mounted on said lower portion of said mast beam portions;
each said telescopic base support members having a locking groove for receiving a respective first and second lock plates upon downward pivoting of said lock plates to the locking position; and
an inverted V-shaped link attachment between said activation knob and said pivoting plates, said link attachment having first and second free ends for pivotal attachment to said respective first and second pivoting lock plates;
whereby upon releasing said spring-loaded knob, said link pulls the V-shaped link attachment downward, rotating said lock plates from the locking position in said telescoping supports, said telescoping supports being in a stored position, thereby allowing said telescoping supports to telescope forward as needed toward said rack server system.

6. The lift system of claim 5, further comprising an auxiliary gripping support comprising a substantially U-shaped member rotatable fixed to said upright mast via first and second supports mounted on corresponding first and second beam members for rotation between an upright stored position at said upper mast portion and a horizontal position, said U-shaped member opening forward around said mast for ease in moving said lift system to a desired position relative to said rack server system.

7. A portable lift system for transporting and installing electronic systems, comprising, in combination with a rack server system:
a rolling support structure having an upright mast, a base, and a support carriage having a telescoping shelf, said base comprising first and second telescopic support members, said telescopic support members having integrally formed therewith first and second wheels for rolling contact with a rolling contact surface, said first and second telescopic support members being integrally formed with a coupling support therebetween for enabling simultaneous rolling and telescopic motion in a direction perpendicular with respect to said mast;
said support carriage having a carriage support bar having a first and second ends and a ring or loop support centrally mounted thereon;
a lifting assembly, said assembly comprising a carriage connector cable, at least one motor, at least one motor support member and at least on cable dispenser driven by said motor for selective lifting and lowering systems via said carriage support bar;
said vertical mast having an upper portion and a lower portion and having first and second upright beam portions;
a pulley support bar mounted at said upper mast portion between said first and second upright beam portions and having a centrally disposed pulley depending therefrom dynamically interconnecting said carriage support bar via a single loop support with said carriage connector cable to said cable dispenser, said at least one slideable carriage support bar having first and second ends which are constrained to move within said first and second beam portions of the mast along the length of the mast and with respect to said motor, said pulley support bar further comprising an operative link to a shelf height adjustment mechanism for making minute height adjustments with respect to a portion of said rack server system.

8. The lift system according to claim 7, wherein said carriage support comprises first and second support arms supporting said shelf at the forward ends thereof.

9. The lift system according to claim 8, wherein said mast further comprises first and second gripping supports for manual rolling transport of the system.

10. The lift system according to claim 8, wherein said mast further comprises a first gripping support mounted on said first mast beam and second gripping support mounted on said second mast beam for manual rolling transport of the system.

11. The lift system according to claim 8, further comprising a motor control module mounted on said mast for controlling lifting power features of said lifting assembly, said control module including at least one operative switch for controlling direction and turning on and off said motor.

12. The lift system according to claim 11, further comprising a lock mechanism for locking said telescopic base support members comprising:
a lock mechanism having a spring-loaded activation knob and a knob support attached between said first and second upright beam portions, said knob being centrally mounted on said knob support;
first and second pivoting lock plates pivotally mounted on said lower portion of said mast beam portions;
each said telescopic base support members having a locking groove for receiving a respective first and second lock plates upon downward pivoting of said lock plates to the locking position; and
an inverted V-shaped link attachment between said activation knob and said pivoting plates, said link attachment having first and second free ends for pivotal attachment to said respective first and second pivoting lock plates;
whereby upon releasing said spring-loaded knob, said link pulls the V-shaped link attachment downward, rotating said lock plates from the locking position in said telescoping supports, said telescoping supports being in a stored position, thereby allowing said telescoping supports to telescope forward as needed toward said rack server system.

13. The lift system of claim 12, further comprising an auxiliary gripping support comprising a substantially U-shaped member rotatable fixed to said upright mast via first and second supports mounted on corresponding first and second beam members for rotation between an upright stored position at said upper mast portion and a horizontal position, said U-shaped member opening forward around said mast for ease in moving said lift system to a desired position relative to said rack server system.

14. The lift system of claim 12, further comprising at lest one roller bearing support located at each end of said slideable carriage support bar, each having roller bearings for rolling contact with said first and second confining upright beam portion of said mast such as to provide for smooth operation between said slideable carriage bar and said confining upright beam portions.
